(19) United States
(12) Patent Application Publication
(10) Pub. No.: US 2015/0364737 A1
(43) Pub. Date: Dec. 17, 2015

(54) METHOD FOR DRYING SEPARATOR FOR NON-AQUEOUS ELECTRIC STORAGE DEVICE AND METHOD FOR MANUFACTURING ELECTRIC STORAGE APPARATUS

(71) Applicant: JTEKT CORPORATION, Osaka-shi (JP)

(72) Inventors: Junya MIYAKE, Toyota-shi (JP); Naoki Ohmi, Chiryu-shi (JP); Takumi Mio, Kariya-shi (JP)

(73) Assignee: JTEKT CORPORATION, Osaka-shi (JP)

(21) Appl. No.: 14/729,674

(22) Filed: Jun. 3, 2015

(30) Foreign Application Priority Data
Jun. 11, 2014 (JP) 2014-120392

(51) Int. Cl. H01M 2/16

(52) U.S. Cl. CPC H01M 2/16

(57) ABSTRACT

In a method for drying a separator for a non-aqueous electric storage device including an organic material that thermally shrinks at a thermal shrinkage start temperature of 100° C. or lower, a solvent impregnation and a drying are executed in this order; the solvent impregnation includes bringing the separator into contact with a solvent that has affinity for water and that causes the azeotropic phenomenon at a temperature lower than the boiling point of water so as to lower an azeotropic temperature of a mixture of moisture in the separator and the solvent below a temperature at which the separator starts thermal shrinkage, and the drying includes drying the separator brought into contact with the solvent at a temperature lower than a temperature at which the separator starts thermal shrinkage and higher than the azeotropic point.

### INCORPORATION BY REFERENCE

The disclosure of Japanese Patent Application No. 2014-120392 filed on Jun. 11, 2014 including the specification, drawings and abstract, is incorporated herein by reference in its entirety.

### BACKGROUND OF THE INVENTION

1. Field of the Invention

The present invention relates to a method for drying a separator for a non-aqueous electric storage device and a method for manufacturing an electric storage apparatus including the separator dried by the drying method.

2. Description of Related Art

A lithium ion secondary battery is a non-aqueous electric storage device containing an electrolytic solution other than a water solution. The non-aqueous electric storage device is used for portable electronic equipment and automotive batteries. The non-aqueous electric storage device stores high energy, and thus, ensuring safety is important for the non-aqueous electric storage device. The non-aqueous electric storage device includes a positive electrode and a negative electrode arranged facing each other via a separator formed of a porous insulating film. When the separator is broken, the positive electrode and the negative electrode may come into direct contact with each other (short circuit). Thus, the separator plays an important role in view of safety.

Furthermore, there has been a demand to improve the productivity of the non-aqueous electric storage device in order to spread the non-aqueous electric storage device to the market (see Japanese Patent Application Publication No. 2000-188114 (JP 2000-188114)). When moisture is mixed into the non-aqueous electric storage device at the time of assembly, the electrolytic solution is decomposed to prevent desired battery performance from being obtained. Thus, before injection of the electrolytic solution is executed, a positive electrode member, a negative electrode member, and a separator are assembled after being sufficiently dried.

In general, the positive electrode member, the negative electrode member, and the separator are dried in a heated state under a reduced pressure. The positive electrode member and the negative electrode member can be dried, due to materials thereof, at 100° C. or higher; the temperature of 100° C. is the boiling point of water under normal pressure (atmospheric pressure on flat land). Therefore, the positive electrode member and the negative electrode member can further be dried in a relatively short time (appropriately two hours). Typically, for the materials of the positive electrode member, the material of current collecting foil is aluminum, and the material of coating film is lithium oxide. For the material of the negative electrode member, the material of current collecting foil is copper, and the material of coating film is natural graphite.

However, the material of the separator is typically polyolefin. For the polyolefin, thermal shrinkage starts at 100° C. or lower. When exposed to a high-temperature environment of 100° C. or higher, the polyolefin thermally shrinks and desired properties thereof fail to be obtained, thus preventing the separator from being dried at a high temperature of 100° C. or higher. Consequently, the separator is dried at a temperature lower than a temperature at which a separator formed of polyolefin starts to thermally shrink, and in a reduced pressure environment. In this case, it takes appropriately 12 hours to dry the separator at 70° C. in the reduced pressure environment, and thus, drying the separator needs a longer time than drying the positive electrode member and the negative electrode member.

As described above, the conventional general method for drying the separator needs a long drying time and is poor in productivity. Furthermore, the drying temperature is equal to or lower than the boiling point of moisture. Thus, even long drying results in moisture remaining in the separator, so sufficient battery performance cannot be achieved.

### SUMMARY OF THE INVENTION

An object of the present invention is to provide a method for drying a separator and a method for manufacturing an electric storage apparatus, in which an azeotropic phenomenon between a low-boiling-point solvent and water is utilized to lower the boiling point of water to allow drying to be easily performed without causing the separator including an organic material to thermally shrink, thus enabling the drying to be achieved in a short time to improve productivity and reduce remaining water as much as possible.

An aspect of the present invention is a method for drying a separator for a non-aqueous electric storage device, the method including:
impregnating a separator with a solvent by bringing the separator into contact with the solvent that has affinity for water and that causes an azeotropic phenomenon at a temperature lower than a boiling point of water so as to mix moisture in the separator with the solvent to produce an azeotropic mixture with an azeotropic point lower than a thermal shrinkage start temperature that is a temperature at which the separator starts thermal shrinkage on heating; and
drying the separator brought into contact with the solvent, wherein
the separator for a non-aqueous electric storage device includes an organic material with a thermal shrinkage start temperature of 100° C. or lower, and
the solvent impregnation and the drying are executed in this order.

In the above-described aspect, in the solvent impregnation, the separator is brought into contact with the solvent that causes the azeotropic phenomenon at the temperature lower than the boiling point of water so that the azeotropic point of the moisture in the separator and the solvent is lower than the thermal shrinkage start temperature that is the temperature at which the separator starts thermal shrinkage. Then, the separator brought into contact with the solvent is dried. Since the azeotropic point is lower than the boiling point of water, the aspect enables a drying time to be reduced compared to the related art, allowing productivity to be improved. In this case, to prevent the separator from thermally shrinking, drying is performed at the temperature that is lower than the thermal shrinkage start temperature and equal to or higher than the azeotropic point. Thus, the moisture in the separator can be efficiently removed and reduced as much as possible.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram depicting a disassembled state of an electric storage apparatus according to the present embodiment;

FIG. 2 is a perspective view depicting the appearance of the electric storage apparatus according to the present embodiment;

FIG. 3 is a plan view separately depicting a positive electrode member, a negative electrode member, and a separator forming a non-aqueous electric storage device in the electric storage apparatus;

FIG. 4 is a plan view depicting a state where the members of the non-aqueous electric storage device depicted in FIG. 3 are combined and laminated;

FIG. 5 is a diagram of steps of manufacturing the separator;

FIG. 6 is a chart illustrating examples of a low-boiling-point solvent that is azeotropic with water;

FIG. 7 is a diagram illustrating an example of a solvent impregnation step;

FIG. 8 is a diagram of steps of manufacturing an electric storage apparatus; and

FIG. 9 is a chart illustrating a capacity maintenance rate.

### DETAILED DESCRIPTION OF EMBODIMENTS

An embodiment of the present invention will be described below using the drawings. The present embodiment is directed to a non-aqueous electric storage device configured as a lamination type device.

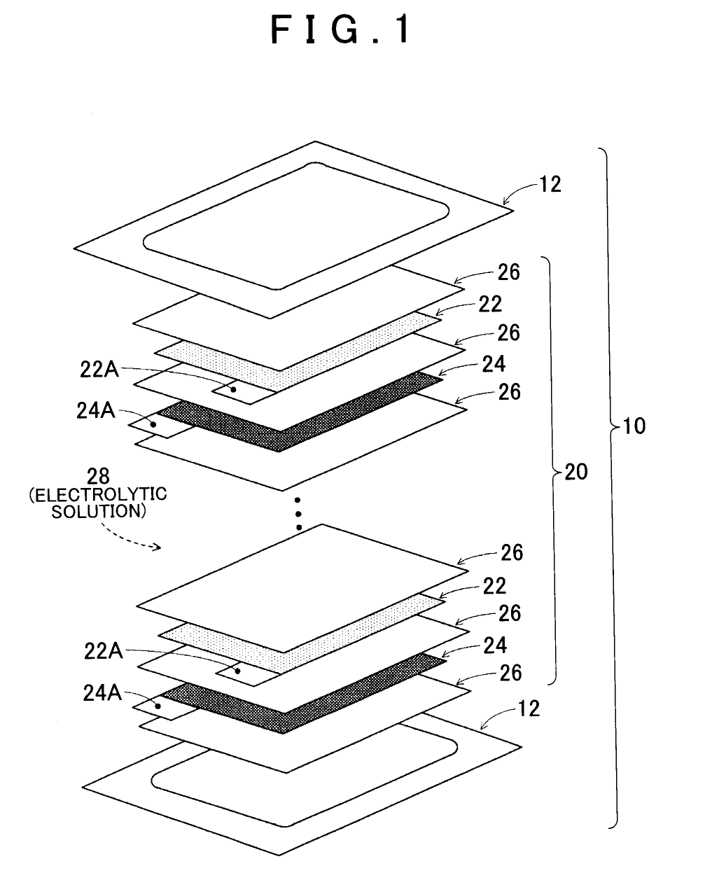

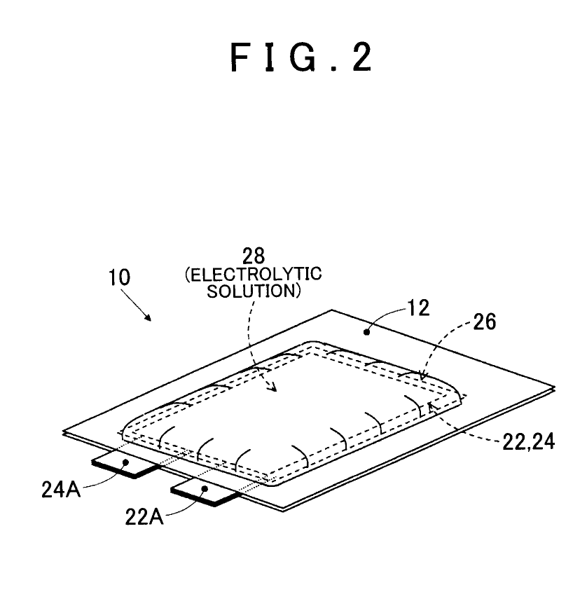

FIG. 1 illustrates a configuration concept of an electric storage apparatus 10 according to the present embodiment in a disassembled state. FIG. 2 depicts the appearance of the electric storage apparatus in an assembled state. The electric storage apparatus 10 depicted in FIG. 1 includes a non-aqueous electric storage device 20 and a non-aqueous electrolytic solution 28 disposed between laminate films 12 disposed at vertically opposite sides of the electric storage apparatus 10. The non-aqueous electric storage device 20 includes positive electrode members 22, negative electrode members 24, and separators 26. In the non-aqueous electric storage device 20, the positive electrode members 22 and the negative electrode members 24 are alternately arranged in a laminated state and the thin-film-like separators 26 each arranged between the positive electrode member 22 and the negative electrode member 24 and at the opposite ends of the non-aqueous electric storage device 20 in a lamination direction. The positive electrode member 22 includes a thin plate or foil the surface of which is, for example, coated with a positive electrode active material. The negative electrode member 24 includes a thin plate or foil the surface of which is, for example, coated with a negative electrode active material. As depicted in FIG. 2, the positive electrode members 22, the negative electrode members 24, and the separators 26 are sandwiched, laminated, and sealed between the laminate films 12 located above and below the positive electrode members 22, the negative electrode members 24, and the separators 26. In this case, an electrolytic solution 28 is also sealed in the non-aqueous electric storage device 20 and interposed among the positive electrode members 22, the negative electrode members 24, and the separators 26.

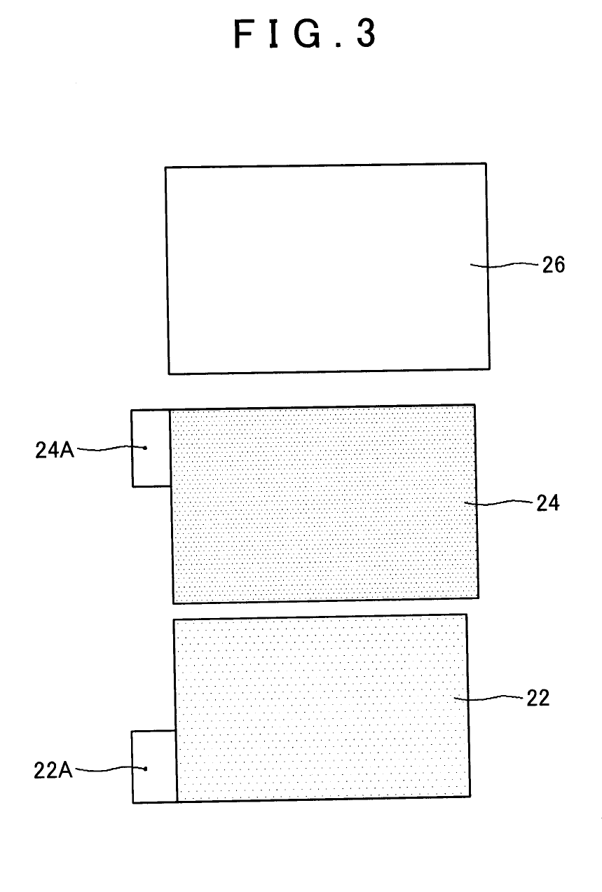

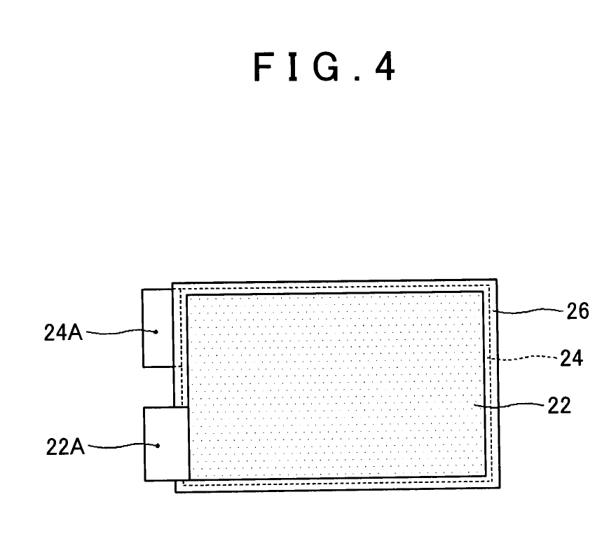

FIG. 3 separately depicts the positive electrode member 22, the negative electrode member 24, and the separator 26 forming the non-aqueous electric storage device 20. The positive electrode member 22, the negative electrode member 24, and the separator 26 each have a plate shape. The positive electrode member 22 and the negative electrode member 24 are provided with a positive electrode terminal 22A and a negative electrode terminal 24A, respectively, on an end surface thereof. When laminated, the positive electrode terminal 22A and the negative electrode terminal 24A are arranged at different positions. FIG. 4 depicts an arrangement state in which the positive electrode member 22 and the negative electrode member 24 are laminated.

The positive electrode member 22 is configured in a well-known manner. The positive electrode member 22 is produced by applying, drying, and rolling a paste on one or both sides of a current collector; the paste contains a positive electrode active material, a binding agent, and a conductive agent as needed, which are kneaded and dispersed in a solvent. The current collector includes an aluminum foil subjected to lath machining (machining in which incisions are made in a material, which is then drawn out to be a net-like structure) or etching. As the positive electrode active material, a lithium-containing transition metal compound that may receive lithium ions as guests is used. The positive electrode member 22 may have a thickness of 130 μm to 200 μm and may be flexible.

The negative electrode member 24 is also configured in a well-known manner. The negative electrode member 24 is produced by applying, drying, and rolling a paste on one or both sides of a current collector; the paste contains a negative electrode active material, a binding agent, and a conductive agent as needed, which are kneaded and dispersed in a solvent. The current collector may be copper or a copper alloy. The current collector may also be a rolled foil or an electrolytic foil and may be shaped like a foil, a porous foil, or an expand material, a lath material, or the like obtained by making incisions in a raw material, which is then drawn out to be a net-like structure. As the negative electrode active material, natural or artificial graphite that can adsorb and desorb lithium ions is used. The negative electrode member 24 may have a thickness of 140 μm to 210 μm and may be flexible.

As the separator 26, an organic material with a thermal shrinkage start temperature of 100° C. or lower (for example, 80° C.) is used. The thermal shrinkage start temperature is a temperature at which the organic material starts thermal shrinkage on heating. Examples of preferable organic materials for the separator include microporous polyolefin resins such as a polyethylene resin and a polypropylene resin. The polyolefin resins function as a safety device if the electric storage device 20 is overheated, and is easy to handle and inexpensive. A method for manufacturing the separator 26 using the organic material according to the present embodiment will be described below.

The electrolytic solution 28 is also well known and contains an electrolyte dissolved in a non-aqueous solvent. As the non-aqueous solution, ethylene carbonate, propylene carbonate, butylene carbonate, dimetyl carbonate, diethyl carbonate, or the like may be used. The non-aqueous solvents may each be used as a single solvent or may be used as a mixed solvent of at least two of these solvents.

In the non-aqueous electric storage device 20 configured as described above, the lithium (Li)-containing transition metal compound is used as the positive electrode active material for the positive electrode member 22. Thus, the positive electrode member 22 emits lithium in the form of ions at the time of charging and adsorbs lithium ions at the time of discharging. Natural or artificial graphite is used as the negative electrode active material for the negative electrode member 24. The negative electrode member 24 adsorbs lithium ions at the time of charging and emits the lithium ions at the time of discharging.

The separator 26 is arranged between the positive electrode member 22 and the negative electrode member 24 in order to enable the positive electrode member 22 and the negative electrode member 24 to perform operations of emitting and adsorbing lithium ions at the time of charging and discharging, while preventing the positive electrode member 22 and the negative electrode member 24 from being short circuited. Thus, the separator 26 is normally configured to have a three layer structure. A central layer is an amorphous porous layer of a polyethylene resin (PE), and opposite end layers are highly crystalline layers of a polypropylene resin (PP). Consequently, the lithium ions are allowed to pass through very narrow passages formed in each layer and can thus be emitted and adsorbed by the positive electrode member and the negative electrode member. However, when heat is generated, the separator 26 is melted without being broken to occlude the very narrow passage formed in each layer, thus blocking the passage of the lithium ions. This inhibits the temperature of the battery from further increasing to ensure safety. As described above, the separator 26 is an important component in view of safety.

Now, a method for manufacturing the above-described separator 26 will be described. In the description of the present embodiment, a separator material being subjected to manufacturing steps and till which moisture has been removed is denoted by reference numeral 26A. The separator from which the moisture has been removed is denoted by reference numeral 26.

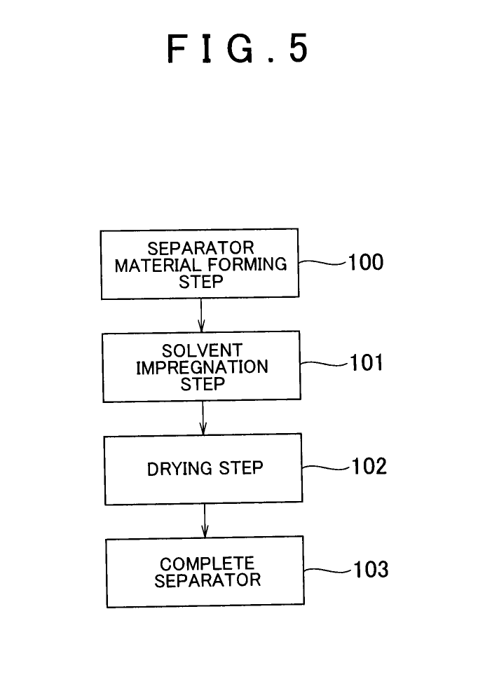

FIG. 5 is a process diagram illustrating the manufacturing steps for the separator 26. First, step 100 is a forming step for the separator material 26A. The forming step 100 for the separator material 26A is executed to form the separator material 26A. As a material for the separator material 26A, an organic material with a thermal shrinkage start temperature of 100° C. or lower is used. In the present embodiment, a microporous polyolefin resin is used. The shape and size of the separator material 26A are as depicted in FIGS. 2 to 4; the separator material 26A has a square plate shape and is formed to have an external size somewhat larger than those of the positive electrode member 22 and the negative electrode member 24.

After the forming step 100, the process proceeds to a solvent impregnation step 101. The solvent impregnation step 101 is executed as a preceding step of a drying step 102. When the separator 26 is used for the non-aqueous electric storage device 20, mixture of moisture in the non-aqueous electric storage device 20 causes the electrolytic solution 28 to be decomposed to prevent desired battery performance from being obtained. Thus, a drying step is needed in which moisture is removed from the non-aqueous electric storage device 20 including the separator 26. Therefore, also for the separator material 26A, drying is performed in the drying step 102, which follows the solvent impregnation step 101, to remove the moisture. To allow the drying step 102 to be efficiently executed in a short drying time, the separator material 26A formed in the forming step 100 is impregnated with a solvent in the solvent impregnation step 101.

As the solvent with which the separator material 26A is impregnated, a material is used which can be dissolved into water or has affinity for water and which causes an azeotropic phenomenon at a lower boiling point than water. The affinity as used herein is a property that allows the solvent to be mixed with water. The azeotropic phenomenon refers to a phenomenon in which, when a liquid mixture boils, a liquid phase and a gaseous phase have the same composition. Such a mixture is referred to as an azeotropic mixture. Impregnation with a solvent of such a material allows water to be removed during the drying step using the azeotropic phenomenon. Moreover, lowering the azeotropic point below the boiling point of water enables a reduction in drying time. As a normal liquid mixture boils, the composition of the mixture changes and a boiling temperature gradually increases. However, for the azeotropic mixture, the composition is unchanged in spite of boiling, with the boiling point remaining constant. For example, the boiling point (azeotropic point) of an azeotropic mixture of water (boiling point: 100° C.) and ethanol (boiling point: 78.3° C.) is lower than the boiling point of either water or ethanol and is 78.2° C., and the azeotropic mixture boils at the constant temperature. (Some azeotropic mixtures have a higher boiling point than each of the components of the mixture.) The azeotropic phenomenon as used herein refers to a phenomenon in which, when liquids are mixed into an azeotropic mixture, the azeotropic mixture has a lower boiling point than those of each of the liquids and has a constant temperature during boiling.

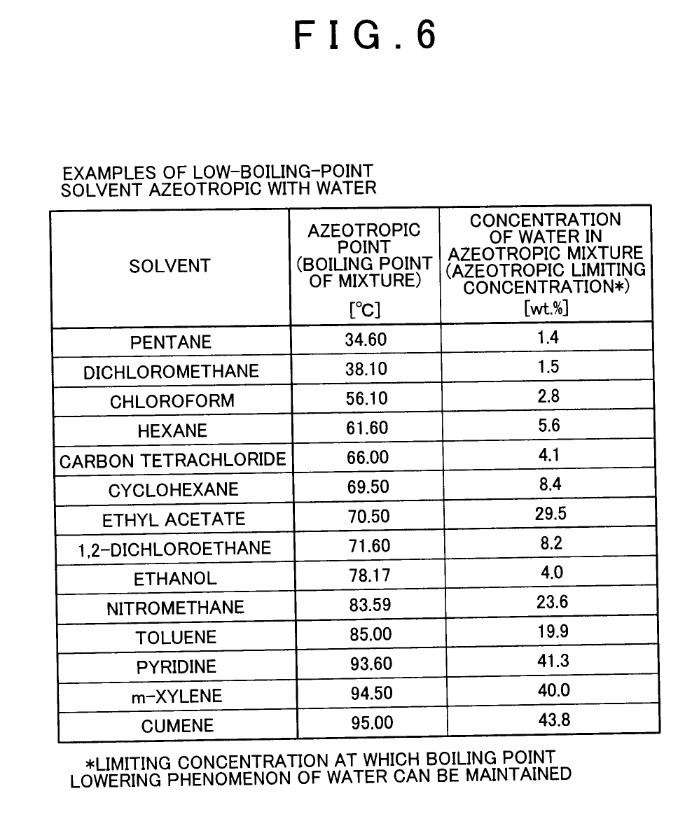

A chart in FIG. 6 illustrates examples of a low-boiling-point solvent that is azeotropic with water. The chart also illustrates the relationship between the azeotropic point at which the solvent used is azeotropic with water and the composition of water. The concentration of water in the azeotropic mixture in the chart, in other words, an azeotropic limiting concentration (wt. %), is the limiting concentration at which a boiling point lowering phenomenon of water can be maintained. In the present embodiment, ethanol is used as the solvent. The ethanol is safe and easy to handle. When the ethanol is used as the solvent, the azeotropic point in an atmospheric state is 78.17° C., and the boiling point of water decreases by approximately 20° C. In this case, the azeotropic limiting concentration is 4.0 wt. %. This means that, for example, when the separator material 26A is impregnated with ethanol of around 100 g, up to 4 g of water in the azeotropic mixture of 100 g can be removed by evaporation at the azeotropic temperature. The water content of the separator material 26A is much lower than the azeotropic limiting concentration of 4.0 wt. % and does not pose a problem in practice.

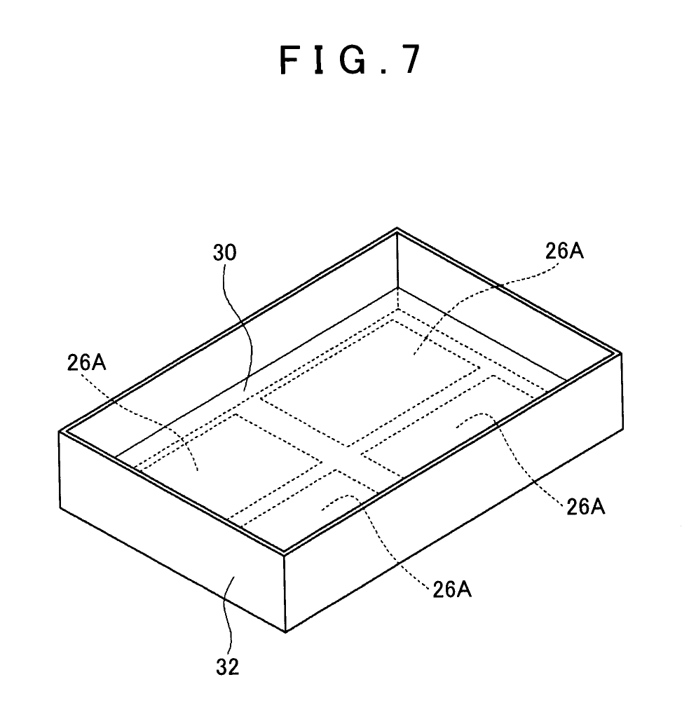

FIG. 7 illustrates an example of a method for impregnating the separator material 26A with a solvent 30 of ethanol. In the method for impregnation with the solvent illustrated in FIG. 7, the separator material 26A is placed in a container 32 with ethanol so as to be impregnated with the ethanol, that is, what is called dipping is performed. Other methods for impregnation include various methods such as dripping of ethanol onto the separator material 26A using a dropper.

When the separator material 26A is impregnated with the solvent 30 of ethanol, the resultant separator material 26A is then dried in the drying step 102. The drying involves heating in an ambience in a reduced pressure state. In the present embodiment, the drying is performed in a vacuum state established by pressure reduction. The vacuum state is at a pressure of approximately 1×10⁻¹ Pa. The pressure reduction enables a reduction in azeotropic point below the azeotropic point in the atmospheric state, allowing the drying to be more efficiently performed. The drying temperature is set lower than a temperature at which the separator material 26A of the organic material thermally shrinks and higher than the azeotropic point in the reduced pressure state. In the present embodiment, polyolefin is used as the separator material 26A, which thermally shrinks at a temperature of approximately 80° C. or higher. The azeotropic point, in the vacuum state, of ethanol, used as the solvent, is lower than 70° C., and thus, the drying temperature was set to 70° C. Thus, during heat drying, the separator material 26A is dried without thermally shrinking. According to the drying method in the present embodiment, since polyolefin has a thermal shrinkage start temperature of approximately 80° C. and starts thermal shrinkage at a lower temperature than a material with a thermal shrinkage start temperature of 100° C. or higher, the passage of ions can be more reliably blocked to easily ensure safety when the electric storage apparatus is overheated.

As a result of the drying under the above-described conditions, the substantially all of the remaining moisture in the separator material 26A was successfully eliminated. Absolute drying may be achieved depending on conditions. In the next step 103, the separator 26 is complete and the production of the separator 26 is complete. The drying method in the above-described present embodiment needs a drying time of approximately one hour, which is a drastic reduction compared to the related art, which needs a drying time of 12 hours.

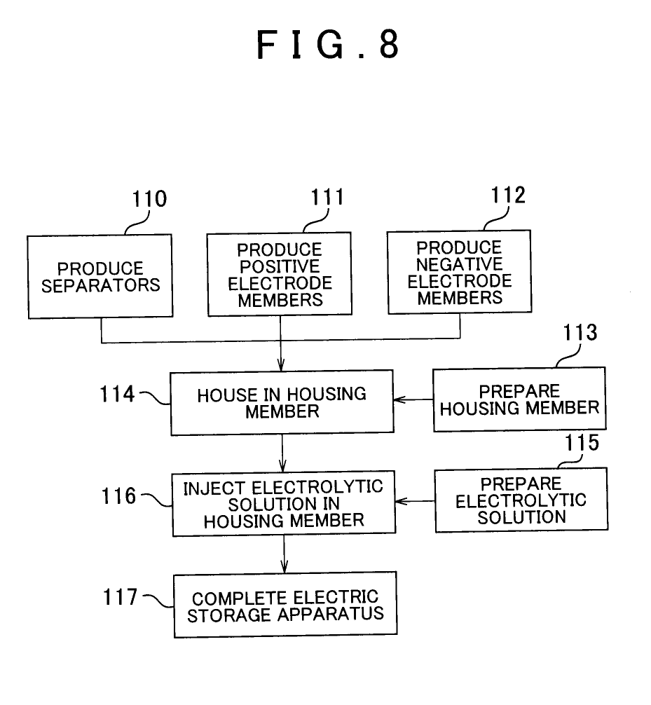

Now, a method for manufacturing the electric storage apparatus 10 using the separator 26 produced by drying in accordance with the above-described drying method will be described based on a process diagram depicted in FIG. 8.

First, in steps 110 to 112, the separators 26, the positive electrode members 22, and the negative electrode members 24 are produced and prepared in advance. In the present embodiment, the separator 26 is produced using the above-described drying method. The positive electrode member 22 and the negative electrode member 24 are configured as described above. For both the positive electrode member 22 and the negative electrode member 24, production steps include a drying step. The positive electrode member 22 and the negative electrode member 24 can originally be dried at high temperature due to the materials used therefor. Consequently, the drying can be achieved in a relatively short time, resulting in a short production time.

Now, step 113 is executed to separately prepare a housing member. In the present embodiment, the housing member is the laminate films 12 depicted in FIG. 1 and FIG. 2. A material for the housing member may be an aluminum alloy containing a slight amount of metal such as manganese or copper, or iron with nickel plating, which is inexpensive, in view of pressure resistance.

In step 114, the positive electrode members 22, the negative electrode members 24, and the separators 26 are housed, in a predetermined arrangement, in the housing member separately prepared in step 113. Then, in step 116, the electrolytic solution 28 separately prepared in step 115 is injected into the housing member. Thus, in step 117, the electric storage apparatus 10 is complete.

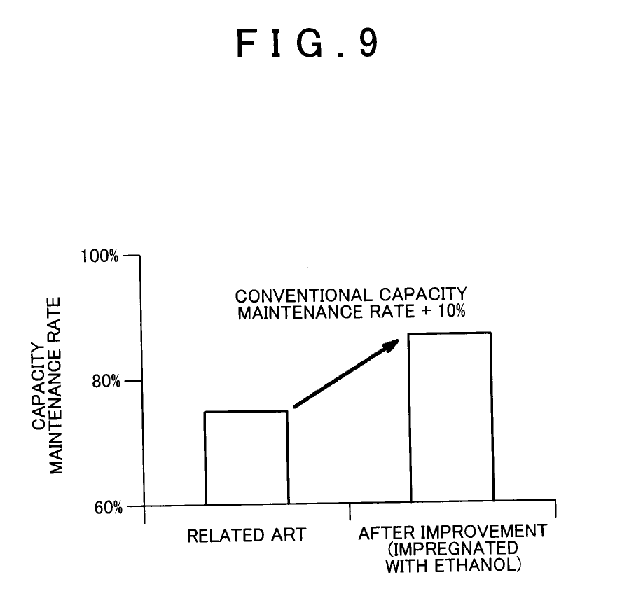

The significantly reduced production time for the separator 26 also significantly reduces the production time for the electric storage apparatus 10 manufactured in the above-described steps. Furthermore, for the electric storage apparatus 10 produced using the separator 26 produced by drying in accordance with the method for drying the separator 26 in the above-described present embodiment, a capacity maintenance rate after charge and discharge cycle tests has increased by approximately 10% as depicted in FIG. 9.

The embodiment of the present invention has been described. However, the present invention can be implemented in various other embodiments. For example, the configuration of the electric storage device in the above-described embodiment is of a lamination type. However, the present invention is applicable to a winding electric storage device and further to various non-aqueous electric storage devices with a separator between a positive electrode and a negative electrode.

In the above-described embodiment, the drying of the separator material 26A is carried out in the vacuum state established by pressure reduction, but may be performed in the atmospheric pressure state. However, in the reduced pressure state, the boiling point is lower, leading to more efficient drying.

What is claimed is:

1. A method for drying a separator for a non-aqueous electric storage device, the method comprising:
impregnating a separator with a solvent by bringing the separator into contact with the solvent that has affinity for water and that causes an azeotropic phenomenon at a temperature lower than a boiling point of water so as to mix moisture in the separator with the solvent to produce an azeotropic mixture with an azeotropic point lower than a thermal shrinkage start temperature that is a temperature at which the separator starts thermal shrinkage on heating; and
drying the separator brought into contact with the solvent, wherein
the separator for a non-aqueous electric storage device includes an organic material with a thermal shrinkage start temperature of 100° C. or lower, and
the solvent impregnation and the drying are executed in this order.

2. The method for drying a separator for a non-aqueous electric storage device according to claim 1, wherein
in the drying, the separator is dried at a temperature that is lower than the thermal shrinkage start temperature of the organic material and higher than the azeotropic point of the azeotropic mixture at a pressure of an ambience in which the drying is executed.

3. The method for drying a separator for a non-aqueous electric storage device according to claim 1, wherein
in the drying, the pressure of the ambience is set lower than an atmospheric pressure.

4. The method for drying a separator for a non-aqueous electric storage device according to claim 2, wherein
in the drying, the pressure of the ambience is set lower than an atmospheric pressure.

5. The method for drying a separator for a non-aqueous electric storage device according to claim 1, wherein
the solvent is ethanol.

6. The method for drying a separator for a non-aqueous electric storage device according to claim 2, wherein
the solvent is ethanol.

7. The method for drying a separator for a non-aqueous electric storage device according to claim 3, wherein
the solvent is ethanol.

8. The method for drying a separator for a non-aqueous electric storage device according to claim 1, wherein
the organic material used for the separator is polyolefin.

9. The method for drying a separator for a non-aqueous electric storage device according to claim 2, wherein
the organic material used for the separator is polyolefin.

10. The method for drying a separator for a non-aqueous electric storage device according to claim 3, wherein
the organic material used for the separator is polyolefin.

11. A method for manufacturing an electric storage apparatus including a positive electrode member, a negative electrode member, an electrolytic solution, a separator, and a housing member that houses the positive electrode member, the negative electrode member, the electrolytic solution, and the separator, the method comprising:
drying the separator by the method for drying a separator for a non-aqueous electric storage device according to claim 1.

12. A method for manufacturing an electric storage apparatus including a positive electrode member, a negative electrode member, an electrolytic solution, a separator, and a housing member that houses the positive electrode member, the negative electrode member, the electrolytic solution, and the separator, the method comprising:
drying the separator by the method for drying a separator for a non-aqueous electric storage device according to claim 2.

13. A method for manufacturing an electric storage apparatus including a positive electrode member, a negative electrode member, an electrolytic solution, a separator, and a housing member that houses the positive electrode member, the negative electrode member, the electrolytic solution, and the separator, the method comprising:
drying the separator by the method for drying a separator for a non-aqueous electric storage device according to claim 3.

14. A method for manufacturing an electric storage apparatus including a positive electrode member, a negative electrode member, an electrolytic solution, a separator, and a housing member that houses the positive electrode member, the negative electrode member, the electrolytic solution, and the separator, the method comprising:
drying the separator by the method for drying a separator for a non-aqueous electric storage device according to claim 5.

15. A method for manufacturing an electric storage apparatus including a positive electrode member, a negative electrode member, an electrolytic solution, a separator, and a housing member that houses the positive electrode member, the negative electrode member, the electrolytic solution, and the separator, the method comprising:
drying the separator by the method for drying a separator for a non-aqueous electric storage device according to claim 8.

16. An electric storage apparatus, comprising:
a separator dried by the method for drying a separator for a non-aqueous electric storage device according to claim 1;
a positive electrode member;
a negative electrode member;
an electrolytic solution; and
a housing member that houses the positive electrode member, the negative electrode member, and the electrolytic solution.

17. An electric storage apparatus, comprising:
a separator dried by the method for drying a separator for a non-aqueous electric storage device according to claim 2;
a positive electrode member;
a negative electrode member;
an electrolytic solution; and
a housing member that houses the positive electrode member, the negative electrode member, and the electrolytic solution.

18. An electric storage apparatus, comprising:
a separator dried by the method for drying a separator for a non-aqueous electric storage device according to claim 3;
a positive electrode member;
a negative electrode member;
an electrolytic solution; and
a housing member that houses the positive electrode member, the negative electrode member, and the electrolytic solution.

19. An electric storage apparatus, comprising:
a separator dried by the method for drying a separator for a non-aqueous electric storage device according to claim 5;
a positive electrode member;
a negative electrode member;
an electrolytic solution; and
a housing member that houses the positive electrode member, the negative electrode member, and the electrolytic solution.

20. An electric storage apparatus, comprising:
a separator dried by the method for drying a separator for a non-aqueous electric storage device according to claim 8;
a positive electrode member;
a negative electrode member;
an electrolytic solution; and
a housing member that houses the positive electrode member, the negative electrode member, and the electrolytic solution.
